(19) United States
(12) Patent Application Publication
(10) Pub. No.: US 2017/0365164 A1
(43) Pub. Date: Dec. 21, 2017

(54) DATA COLLECTION SYSTEM

(71) Applicant: TOSHIBA MITSUBISHI-ELECTRIC INDUSTRIAL SYSTEMS CORPORATION, Chuo-ku (JP)

(72) Inventor: Noriyuki MAEHATA, Tokyo (JP)

(73) Assignee: TOSHIBA MITSUBISHI-ELECTRIC INDUSTRIAL SYSTEMS CORPORATION, Chuo-ku (JP)

(21) Appl. No.: 15/696,764

(22) Filed: Sep. 6, 2017

Related U.S. Application Data
(63) Continuation of application No. PCT/JP2015/056648, filed on Mar. 6, 2015.

(51) Int. Cl. G08C 23/04; G08C 19/02

(52) U.S. Cl. CPC G08C 23/04; G08C 19/025

(57) ABSTRACT

A data collection system includes sensors which are synchronized with each other and an optical signal distributor, wherein each of the sensors comprises a first delay unit which delays a second electrical signal for a first delay time set such that a sum of the first delay time and a first conversion time is same in all of the sensors, and the optical signal distributor comprises second delay units each of which delays a first electrical signal for a second delay time set such that all of sums of the second delay times and conversion times are same as each other.

### CROSS REFERENCE TO RELATED APPLICATIONS

This application is a Continuation Application of PCT Application No. PCT/JP2015/056648, filed Mar. 6, 2015, the entire contents of which are incorporated herein by reference.

### BACKGROUND OF THE INVENTION

### 1. Field of the Invention

Embodiments described herein relate generally to a data collection system for collecting measurement data by a plurality of sensors.

### 2. Description of the Related Art

In general, systems for monitoring the target by collecting measurement data obtained by a plurality of detectors provided in places distant from each other are known. For example, a monitoring device which monitors partial discharge generated in a high-voltage device based on the time of change in measurement data and the data is disclosed (see Patent Literature 1). A data collection system for collecting the measurement data of the same-time of sensors with high accuracy in consideration of transmission delay is disclosed (see Patent Literature 2).

However, when a plurality of sensors are synchronized with each other in consideration of transmission delay, the settings are dependent on the configuration of the system. Therefore, when the configuration of the system has been changed, the settings need to be changed to synchronize the sensors with each other. For example, even when a single sensor has been replaced, a setting operation for synchronization needs to be performed for the other sensors. Such a setting operation is troublesome.

### CITATION LIST

### Patent Literature

Patent Literature 1 JP 2002-131366 A

Patent Literature 2 JP 2010-218056 A

### BRIEF SUMMARY OF THE INVENTION

Embodiments described herein aim to provide a data collection system capable of simplifying a setting operation for synchronizing a plurality of sensors.

In accordance with an aspect of the present invention, there is provided a data collection system. the data collection system comprises a plurality of sensors which are synchronized with each other; and an optical signal distributor, wherein each of the sensors comprises: a physical quantity measurement unit which measures a physical quantity; a first optical signal transmission unit which transmits a first optical signal to the optical signal distributor when the measured physical quantity satisfies a predetermined condition; a first signal converter which converts a second optical signal received from the optical signal distributor into a second electrical signal; a first delay unit which delays the second electrical signal obtained by the first signal converter for a first delay time set such that a sum of the first delay time and a first conversion time by the first signal converter is same in all of the sensors; and a data transmission unit which transmits the physical quantity measured at a time the condition is satisfied when the physical quantity satisfies the condition, and transmits the physical quantity measured a predetermined time before a receipt time of the second electrical signal when the data transmission unit receives the second electrical signal delayed by the first delay unit, and the optical signal distributor comprises: a plurality of second signal converters which convert the first optical signals output from the sensors into first electrical signals, respectively; a plurality of second delay units each of which delays the first electrical signal obtained by the corresponding second signal converter for a second delay time set such that all of sums of the second delay times and conversion times by the second signal converters are same as each other; and a second optical signal transmission unit which transmits the second optical signal to the first signal converter of each of the sensors when the second optical signal transmission unit receives the delayed first electrical signal from at least one of the second delay units.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a configuration diagram showing the configuration of a data collection system according to a first embodiment of the present invention.

FIG. 2 is a configuration diagram showing the transmission time of trigger signals in the data collection system according to the present embodiment.

FIG. 3 is a configuration diagram showing the configuration of a sensor according to a second embodiment of the present invention.

### DETAILED DESCRIPTION OF THE INVENTION

### First Embodiment

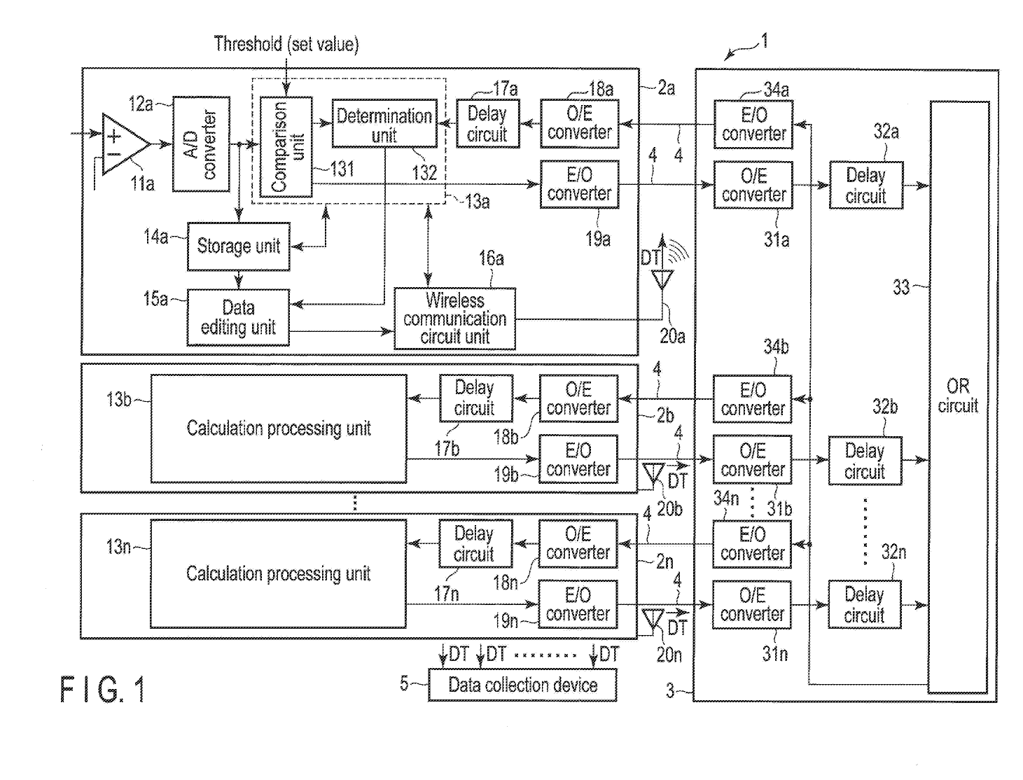

FIG. 1 is a configuration diagram showing the configuration of a data collection system 1 according to a first embodiment of the present invention. In the drawings, the same elements are denoted by like reference numbers, and redundant description is omitted.

The data collection system 1 comprises n sensors 2a, 2b, . . . 2n, an optical signal distributor 3, a plurality of optical transmission channels 4, and a data collection device 5. The number of sensors 2a to 2n is not particularly limited as long as it is greater than or equal to two. Each of sensors 2a to 2n is connected to the optical signal distributor 3 by two optical transmission channels 4 for transmission and reception. The optical transmission channels 4 are, for example, optical fibers. The data collection device 5 may not be an element included in the data collection system 1. The data collection device 5 may be provided in any place as long as it is capable of receiving measurement data DT from sensors 2a to 2n.

Sensors 2a to 2n are provided at measurement positions in or around an electronic device, etc. Sensors 2a to 2n measure a physical quantity such as voltage, current, electromagnetic waves by sampling a change in the physical quantity on the order of nanoseconds. Sensors 2a to 2n wirelessly transmit the measurement data DT of the measured physical quantity to the data collection device 5 which collects the measurement data DT. Sensors 2a to 2n transmit the measurement data DT based on two triggers, specifically, an internal trigger generated by a change in the physical quantity measured by itself and an external trigger generated by a change in the physical quantity measured by the other sensors 2a to 2n.

All of sensors 2a to 2n are structured in the same way except that the measurement target (for example, the measurement position or the physical quantity to be measured) differs. Here, a single sensor 2a is explained. The explanation of the other sensors 2b to 2n is omitted since they are structured in the same manner as that of sensor 2a.

Sensor 2a comprises an analog signal input unit 11a, an analog/digital converter 12a, a calculation processing unit 13a, a data storage unit 14a, a data editing unit 15a, a wireless communication circuit 16a, a delay circuit 17a, an O/E converter 18a, an E/O converter 19a, and a wireless communication antenna 20a. Sensor 2a further comprises structures necessary for synchronization, such as a reference oscillator.

An analog signal (electrical signal) indicating the physical quantity, which is measurement object of sensor 2a, is input to the analog signal input unit 11a. The analog signal input unit lla converts the input analog signal into an analog signal to be dealt with as a measurement value (measurement data), and outputs the analog signal to the analog/digital converter 12a.

The analog/digital converter 12a converts the measurement value of the analog signal input from the analog signal input unit 11a into a digital signal. The analog/digital converter 12a outputs the measurement value of the obtained digital signal to the calculation processing unit 13a and the data storage unit 14a.

The calculation processing unit 13a is configured to be realized when an element such as a central processing unit (CPU) is executed in accordance with a program, etc. The calculation processing unit 13a samples the measurement values (digital signals) output from the analog/digital converter 12a on the order of nanoseconds. The calculation processing unit 13a writes the sampled measurement values to the data storage unit 14a. Further, for example, the calculation processing unit 13a monitors and controls the components or elements provided in sensor 2a.

The data storage unit 14a is a memory which stores the sampled measurement values in chronological order. The capacity of the data storage unit 14a is sufficiently large so as to correspond to the function of sensor 2a. For example, the data storage unit 14a stores data in accordance with a ring buffer system.

The calculation processing unit 13a comprises a comparison unit 131 and a determination unit 132.

The measurement values input from the analog/digital converter 12a and sampled are input to the comparison unit 131. The comparison unit 131 compares the sampled measurement values with a predetermined threshold (set value). When a sampled measurement value exceeds the threshold, the comparison unit 131 outputs an internal trigger signal to the determination unit 132 and E/O converter 19a. Here, when a measurement value exceeds the threshold, an internal trigger signal is output. However, as long as an internal trigger signal is output when a measurement value satisfies a predetermined condition, the condition may be any condition. For example, an internal trigger signal may be output when a measurement value is less than the set value. Alternatively, an internal trigger signal may be output when the amount of change in the measurement values exceeds the set value.

The internal trigger signal output from the comparison unit 131 and an external trigger signal output from the other sensors 2b to 2n are input to the determination unit 132. When the determination unit 132 receives both an internal trigger signal and an external trigger signal, the determination unit 132 determines that the measurement value of the own sensor 2a exceeds the threshold (in other words, detection by the own sensor 2a). When the determination unit 132 receives an external trigger signal and does not receive an internal trigger signal, the determination unit 132 determines that the measurement value of the other sensors 2b to 2n exceeds the threshold (in other words, detection by the other sensors 2b to 2n). The determination unit 132 outputs, to the data editing unit 15a, a trigger signal for an instruction that data should be edited and transmitted together with the result of determination.

When the data editing unit 15a receives the result of determination and the trigger signal from the determination unit 132, the data editing unit 15a loads measurement data from the data storage unit 14a based on the result of determination. When the result of determination of the determination unit 132 indicates detection by the own sensor 2a, the data editing unit 15a loads the measurement data measured at the time of generation of the internal trigger signal from the data storage unit 14a. When the result of determination of the determination unit 132 indicates detection by the other sensors 2b to 2n, the data editing unit 15a loads, from the data storage unit 14a, measurement data measured a predetermined time before the receipt time of the external trigger signal. The data editing unit 15a adds information necessary for wireless transmission, such as a header and footer, to the measurement data loaded from the data storage unit 14a, and generates a packet for wireless transmission. The measurement data put by the data editing unit 15a in the packet may be any type of measurement data as long as the measurement data can be obtained from the data stored in the data storage unit 14a. For example, the measurement data put in the packet may be the instantaneous value or effective value of the applicable time. Alternatively, the measurement data may be waveform data obtained by, for example, editing the measurement values before and after the applicable time. The data editing unit 15a outputs the generated packet to the wireless communication circuit 16a.

The wireless communication circuit 16a outputs, via the wireless communication antenna 20a, the packet including the measurement data DT received from the data editing unit 15a. In this way, the measurement data DT of sensor 2a is wirelessly transmitted to the external data collection device 5.

O/E converter 18a receives an external trigger signal (optical signal) generated by detection of the other sensors 2b to 2n from the optical signal distributor 3 via the optical transmission channel 4. O/E converter 18a converts the received external trigger signal as an optical signal into an electrical signal. O/E converter 18a outputs the external trigger signal converted into the electrical signal to delay circuit 17a.

Delay circuit 17a outputs the external trigger signal input from O/E converter 18a to the determination unit 132 after a predetermined delay time. The delay time set in delay circuit 17a is determined based on the time required for the conversion by O/E converter 18a (conversion time).

E/O converter 19a converts an internal trigger signal input from the comparison unit 131 as an electrical signal into an optical signal. E/O converter 19a outputs the internal trigger signal converted into the optical signal to the optical signal distributor 3 via the optical transmission channel 4. The internal trigger signal output from E/O converter 19a is a signal to be dealt with as an external signal by the other sensors 2b to 2n.

When the optical signal distributor 3 receives the internal trigger signal as the optical signal output from arbitrary sensors 2a to 2n, the optical signal distributor 3 distributes the optical signal to all of the other sensors 2a to 2n as an external trigger signal.

The optical signal distributor 3 comprises n O/E converters 31a to 31n, n delay circuits 32a to 32n, an OR circuit 33, and n E/O converters 34a to 34n. The number of O/E converters 31a to 31n, the number of delay circuits 32a to 32n and the number of E/O converters 34a to 34n are equal to the number of sensors 2a to 2n in a corresponding manner. Here, O/E converter 31a, delay circuit 32a and E/O converter 34a corresponding to a single sensor 2a are mainly explained. The explanation of the other elements is omitted since they are structured in the same manner as that of the elements of sensor 2a.

O/E converter 31a receives a trigger signal (internal trigger signal) which is an optical signal from sensor 2a. O/E converter 31a converts the received trigger signal as an optical signal into an electrical signal. O/E converter 31a outputs the trigger signal converted into the electrical signal to delay circuit 32a.

Delay circuit 32a outputs the trigger signal input from O/E converter 31a to the OR circuit 33 after a predetermined delay time. The delay time set in delay circuit 32a is determined based on the time required for the conversion by O/E converter 31a (conversion time).

Trigger signals are input to the OR circuit 33 from all of delay circuits 32a to 32n corresponding to all of sensors 2a to 2n. The OR circuit 33 implements the OR operation of trigger signals from all of delay circuits 32a to 32n, and outputs the result of operation to E/O converters 34a to 34n corresponding to all of sensors 2a to 2n. Thus, when the OR circuit 33 receives a trigger signal from at least one of delay circuits 32a to 32n, the OR circuit 33 outputs trigger signals to all of E/O converters 34a to 34n.

E/O converter 34a receives a trigger signal which is an electrical signal from the OR circuit 33. E/O converter 34a converts the received trigger signal as an electrical signal into an optical signal. E/O converter 34a transmits the trigger signal converted into the optical signal to sensor 2a via the optical transmission channel 4 as an external trigger signal.

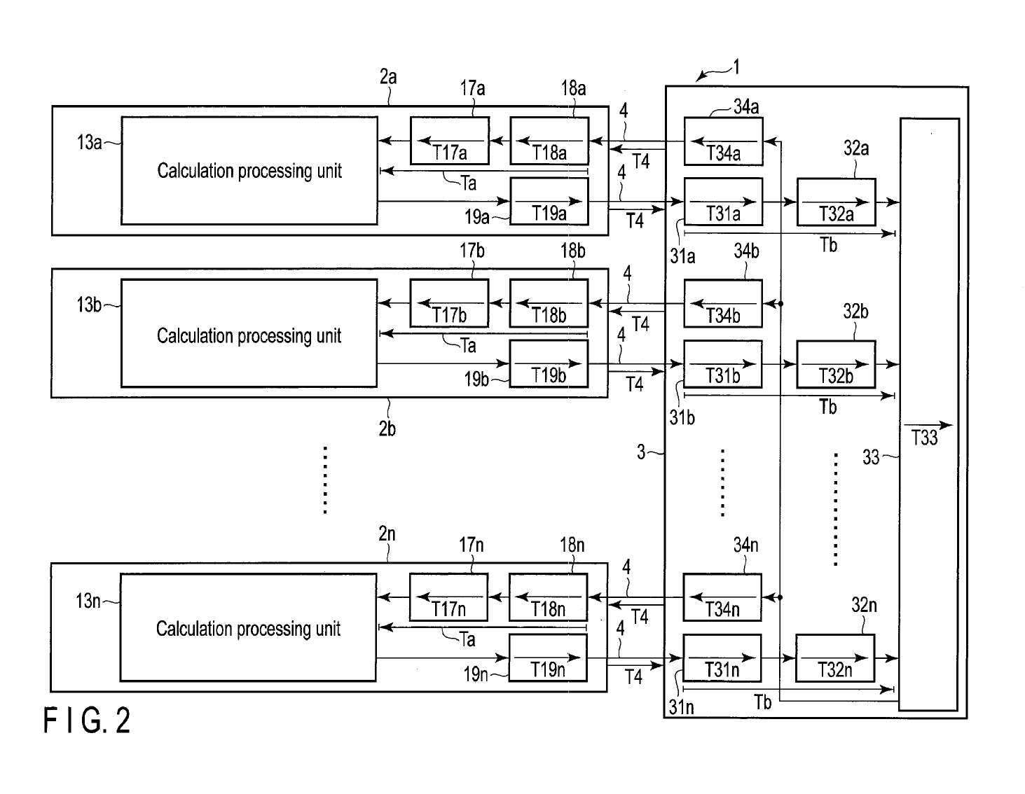

FIG. 2 is a configuration diagram showing the transmission time of trigger signals in the data collection system 1 according to the present embodiment.

This specification explains a method for determining delay times T17a to T17n set in delay circuits 17a to 17n of sensors 2a to 2n, and delay times T32a to T32n set in delay circuits 32a to 32n of the optical signal distributor 3.

All of conversion times T18a to T18n and T31a to T31n required for O/E converters 18a to 18n and 31a to 31n to convert an optical signal into an electrical signal differ depending on the converter. For example, conversion times T18a to T18n and T31a to T31n differ by approximately 100 nanoseconds. All of the conversion times required for E/O converters 19a to 19n and 34a to 34n to convert an electrical signal into an optical signal can be regarded as zero.

In sensors 2a to 2n, delay times T17a to T17n are set such that all of the sums of delay times T17a to T17n of delay circuits 17a to 17n and conversion times T18a to T18n of O/E converters 18a to 18n are the same time Ta. Time Ta is set so as to be greater than the individual difference in conversion times T18a to T18n of O/E converters 18a to 18n. Time Ta is a delay time required for an external trigger signal received in O/E converters 18a to 18n to reach calculation processing units 13a to 13n in sensors 2a to 2n.

In the optical signal distributor 3, delay times T32a to T32n are set such that all of the sums of delay times T32a to T32n of delay circuits 32a to 32n and conversion times T31a to T31n of O/E converters 31a to 31n are the same time Tb. Time Tb is set so as to be greater than the individual difference in conversion times T31a to T31n of O/E converters 31a to 31n. Time Tb is a delay time required for the internal trigger signals received from sensors 2a to 2n in O/E converters 31a to 31n of the optical signal distributor 3 to reach the OR circuit 33.

This specification explains delay time Td required for an internal trigger signal generated in sensor 2b to reach sensor 2a as an external trigger signal. Here, it is assumed that all of the optical transmission channels 4 connecting sensors 2a to 2n and the optical signal distributor 3 have the same length.

Delay time Td is shown by the following equation.

Td=T19b+T4+T31b+T32b+T33+T34a+T4+T18a+T17a (1)

Here, time T4 is a time (signal transmission time) required for the transmission of an optical signal through the optical transmission channel 4. Time T33 is the operation processing time in the OR circuit 33. Time T19b is the conversion time of a signal in E/O convertor 19b. Time T34a is the conversion time of a signal in E/O converter 34a.

As described above, delay times T17a to T17n and T32a to T32 of delay circuits 17a to 17n and 32a to 32n are set. Thus, the following equations are established.

Ta=T17a+T18a=T17b+T18b= . . . =T17n+T18n (2)

Tb=T31a+T32a=T31b+T32b= . . . =T31n+T32n (3)

When equations (2) and (3) are substituted into equation (1), the following equation is obtained.

Td=T19b+T4+Tb+T33+T34a+T4+Ta (4)

Here, conversion times T19b and T34a of E/O converters 19b and 34a can be regarded as zero. Thus, the following equation is obtained from equation (4).

Td=T4+Tb+T33+T4+Ta (5)

Here, the operation processing time T33 of the OR circuit 33 is fixed. The signal transmission time T4 of the optical transmission channel 4 is determined by the length of the cable, and is fixed.

Time Ta and time Tb are also fixed. Thus, delay time Td is a fixed time.

For example, conditions are set to T4=10 [ns] (corresponding to an optical fiber cable of 2 m), T31b=34 [ns], T33=5 [ns], T18a=60 [ns], Ta=200 [ns] and Tb=150 [ns].

Delay time Td is obtained from equation (5) as follows.

Td=10+150+5+10+200=375 [ns]

Under the above conditions, when sensor 2a receives a trigger signal generated in sensor 2b, sensor 2a obtains the measurement value measured 375 nanoseconds before the receipt time of the trigger signal such that sensor 2a is synchronized with the measurement value of sensor 2b at the generation time of the trigger signal.

At this time, delay time T32b of delay circuit 32b and delay time T17a of delay circuit 17a are obtained from equations (2) and (3) as follows.

T32b=Tb−T31b=150−34=116 [ns] (6)

T19a=Ta−T18a=200−60=140 [ns] (7)

Delay times T17a and T32b are obtained by determining times Ta and Tb and measuring conversion times T19b and T34a of E/O converters 19b and 34a. The obtained delay times T17a and T32b are set in delay circuits 17a and 32b before operation. This process is performed for all of delay circuits 17a to 17n and 32a to 32n.

In the present embodiment, a plurality of sensors 2a to 2n can be synchronized with each other with high accuracy. In this way, the data collection system 1 is capable of collecting measurement values determined as the same time with high accuracy from a plurality of sensors 2a to 2n.

For example, when delay circuits 17a to 17n and 32a to 32n are configured as delay elements which can be set in units of 0.1 nanoseconds, delay times T17a to T17n and T32a to T32n can be set in units of 0.1 nanoseconds. In this case, the accuracy of synchronization of measurement times among a plurality of sensors 2a to 2n can be set in units of 0.1 nanoseconds.

The data collection system 1 comprises sensors 2a to 2n comprising delay circuits 17a to 17n, and the optical signal distributor 3 comprising delay circuits 32a to 32n. Thus, even when an arbitrary combination of sensors 2a to 2n and the optical signal distributor 3 is selected, the setting operation of delay times T17a to T17n and T32a to T32n can be simplified. For example, when there is a need to replace any one of sensors 2a to 2n and the optical signal distributor 3, the setting operation for synchronization in the data collection system 1 can be completed by changing the settings for only delay circuits 17a to 17n or 32a to 32n provided in the new device (sensors 2a to 2n or the optical signal distributor 3).

### Second Embodiment

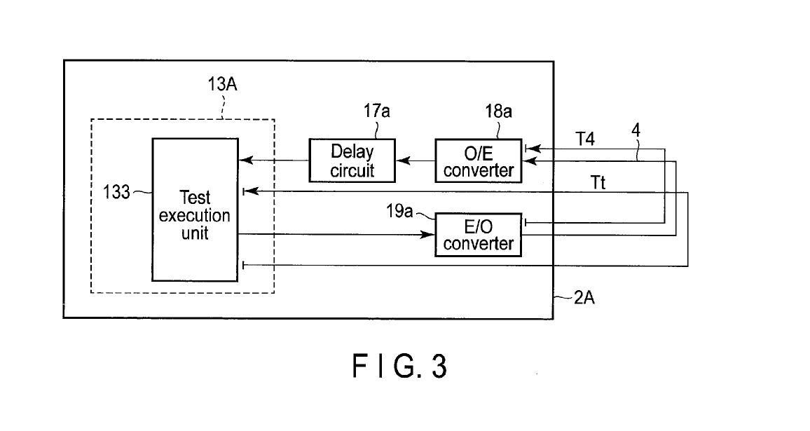

FIG. 3 is a configuration diagram showing the configuration of a sensor 2A according to a second embodiment of the present invention.

The present embodiment comprises a data collection system 1 realized by providing a sensor 2A in place of each of sensors 2a to 2n in the data collection system 1 of the first embodiment shown in FIG. 1. The other structures are the same as those of the first embodiment.

Sensor 2A comprises a calculation processing unit 13A in place of calculation processing unit 13a in sensor 2a of the first embodiment shown in FIG. 1. The other structures of sensor 2A are the same as those of sensor 2a of the first embodiment.

Calculation processing unit 13A is realized by adding a test execution unit 133 to calculation processing unit 13a of the first embodiment. The other structures of calculation processing unit 13A are the same as those of calculation processing unit 13a of the first embodiment. For the sake of convenience, FIG. 3 shows only the test execution unit 133.

The test execution unit 133 performs a calculation process for executing a test mode (a function of measuring a signal delay time). The test execution unit 133 measures the signal delay time Tt between the output of a test signal and the reception in itself via an optical transmission channel 4. When the applied mode has been switched to a test mode, the test execution unit 133 performs a calculation process for carrying out a test. The applied mode may be switched between a normal mode executed in an operation state and a test mode in any manner. For example, the mode may be switched by either software or hardware. The mode may be artificially switched, or may be switched by automatically identifying an operation state or a test state.

Now, this specification explains a method for implementing a test for measuring the signal delay time Tt.

The test is carried out in a stand-alone state where sensor 2A is separated from the data collection system 1. The test may be conducted without separating sensor 2A from the data collection system 1.

A worker connects a terminal which outputs an internal trigger signal and a terminal to which an external trigger signal is input via the optical transmission channel 4 such that a trigger signal output from sensor 2A is received in itself. Specifically, the worker connects the output side of an E/O converter 19a and the input side of an O/E converter 18a via the optical transmission channel 4.

After the connection of the optical transmission channel 4, the worker performs an operation to cause sensor 2A to execute a test. By this operation, the test execution unit 133 outputs a test signal which is a trigger signal for a test.

The test signal output from the test execution unit 133 as an electrical signal is converted into an optical signal by E/O converter 19a. The test signal converted into the optical signal is output from E/O converter 19a to the optical transmission channel 4. O/E converter 18a receives the test signal via the optical transmission channel 4. O/E converter 18a converts the received test signal as the optical signal into an electrical signal, and outputs the electrical signal to a delay circuit 17a. Delay circuit 17a outputs the signal to the test execution unit 133 a predetermined delay time T17a after the reception of the test signal. Here, it is assumed that delay time T17a is set to zero in a test mode. Therefore, when delay circuit 17a receives a test signal, delay circuit 17a transmits the test signal without any delay. The test execution unit 133 measures the time between the transmission and the reception of the test signal.

In this case, the signal delay time Tt is shown by the following equation.

Tt=T19a+T4+T18a+T17a (8)

Here, both conversion time T19a of E/O converter 19a and delay time T17a of delay circuit 17a are set to zero.

Thus, the following equation can be obtained from equation (8).

Tt=T4+T18a (9)

The signal transmission time T4 of the optical transmission channel 4 is determined by obtaining the length of the optical transmission channel 4. Thus, when the signal delay time Tt is measured, conversion time T18a of O/E converter 18a is obtained.

The worker sets delay time T17a in delay circuit 17a based on the obtained conversion time T18a of O/E converter 18a such that the sum of delay time T17a of delay circuit 17a and conversion time T18a of O/E converter 18a is predetermined time Ta. Time Ta is a time used to realize a situation in which the sum of delay time T17a of delay circuit 17a and conversion time T18a of O/E converter 18a is the same in all of sensors 2A. Delay time T17a may be automatically set in delay circuit 17a in sensor 2A after the test by setting time Ta and the signal transmission time T4 of the optical transmission channel 4 in sensor 2A in advance.

In addition to the effects of the first embodiment, the following effect can be obtained by the present embodiment.

A test mode (a function of measuring a signal delay time) for measuring the signal delay time Tt between the transmission of a test signal and the reception of the returned test signal is provided in sensor 2A. Thus, in sensor 2A, delay time T17a of delay circuit 17a can be easily set.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted from all of the constituent elements disclosed in the embodiments. The constituent elements described in different embodiments may be arbitrarily combined with each other.

What is claimed is:

1. A data collection system comprising:
a plurality of sensors which are synchronized with each other; and
an optical signal distributor, wherein
each of the sensors comprises:
a physical quantity measurement unit which measures a physical quantity;
a first optical signal transmission unit which transmits a first optical signal to the optical signal distributor when the measured physical quantity satisfies a predetermined condition;
a first signal converter which converts a second optical signal received from the optical signal distributor into a second electrical signal;
a first delay unit which delays the second electrical signal obtained by the first signal converter for a first delay time set such that a sum of the first delay time and a first conversion time by the first signal converter is same in all of the sensors; and
a data transmission unit which transmits the physical quantity measured at a time the condition is satisfied when the physical quantity satisfies the condition, and transmits the physical quantity measured a predetermined time before a receipt time of the second electrical signal when the data transmission unit receives the second electrical signal delayed by the first delay unit, and
the optical signal distributor comprises:
a plurality of second signal converters which convert the first optical signals output from the sensors into first electrical signals, respectively;
a plurality of second delay units each of which delays the first electrical signal obtained by the corresponding second signal converter for a second delay time set such that all of sums of the second delay times and conversion times by the second signal converters are same as each other; and
a second optical signal transmission unit which transmits the second optical signal to the first signal converter of each of the sensors when the second optical signal transmission unit receives the delayed first electrical signal from at least one of the second delay units.

2. The data collection system of claim 1, wherein
the data transmission unit performs wireless transmission.

3. The data collection system of claim 1, wherein
the data transmission unit edits the measured physical quantity and performs transmission.

4. The data collection system of claim 1, wherein
the sensors comprise:
a test signal output unit which outputs a test signal; and
a time measurement unit which measures a time between output of the test signal by the test signal output unit and reception through transmission by the first optical signal transmission unit and conversion by the first signal converter into an electrical signal.

5. The data collection system of claim 1, further comprising a data collection device which receives the physical quantity measured by the sensors.

6. A data collection method using a plurality of sensors which are synchronized with each other and an optical signal distributor, wherein
each of the sensors is configured to:
measure a physical quantity;
transmit a first optical signal to the optical signal distributor when the measured physical quantity satisfies a predetermined condition;
convert a second optical signal received from the optical signal distributor into a second electrical signal;
delay the obtained second electrical signal for a first delay time set such that a sum of the first delay time and a conversion time for conversion into the second electrical signal is same in all of the sensors; and
transmit the physical quantity measured at a time the condition is satisfied when the physical quantity satisfies the condition, and transmit the physical quantity measured a predetermined time before a receipt time of the second electrical signal when the delayed second electrical signal is received, and
the optical signal distributor is configured to:
convert the first optical signal output from each of the sensors into a first electrical signal;
delay the obtained first electrical signal for a second delay time set such that all of sums of the second delay times and conversion times for conversion into the first electrical signals are same as each other; and
transmit the second optical signal to each of the sensors when the at least one delayed first electrical signal is received.
